(19) United States
(12) Patent Application Publication
(10) Pub. No.: US 2014/0114501 A1
(43) Pub. Date: Apr. 24, 2014

(54) METHOD FOR CONTROLLING VEHICLE-MOUNTED DEVICE BY PORTABLE TERMINAL

(71) Applicant: QUANTA STORAGE INC., Taoyuan County (TW)

(72) Inventors: Yao-Wen Chang, Taoyuan County (TW); Wen-Jing Lin, Taoyuan County (TW)

(73) Assignee: QUANTA STORAGE INC., Taoyuan County (TW)

(21) Appl. No.: 13/893,578

(22) Filed: May 14, 2013

(30) Foreign Application Priority Data
Oct. 24, 2012 (CN) 201210408567.3

(51) Int. Cl. G06F 17/00

(52) U.S. Cl. CPC G06F 17/00
USPC 701/2

(57) ABSTRACT

A method for controlling a vehicle-mounted device by a portable terminal is provided. The method comprises the following steps. The vehicle-mounted device is turned on. A synchronous mode is started. Connection to the portable terminal is confirmed. The vehicle-mounted device is switched to the synchronous mode. An operation module is selected. A stored pattern of operation modes of the operation module is transmitted to the portable terminal. An operation module on the portable terminal is started for enabling the vehicle-mounted device to playback the function mode corresponding to the operation module and controlling the vehicle-mounted device by operating the operation mode on the portable terminal.

This application claims the benefit of People's Republic of China application Serial No. 201210408567.3, filed Oct. 24, 2012, the subject matter of which is incorporated herein by reference.

### BACKGROUND OF THE INVENTION

1. Field of the Invention

The invention relates in general to a method for controlling a vehicle-mounted device, and more particularly to a method for controlling a vehicle-mounted device by using a smart portable terminal to select a part of the operation modules of the vehicle-mounted device.

2. Description of the Related Art

Due to the rapid development in the smart portable terminal, each smart portable terminal is equipped with essential components for performing a diversity of functions. Meanwhile, the vehicle-mounted device is upgraded along with the development of the smart portable terminal. As the control mechanism between the portable terminal and the vehicle-mounted device is getting more and more complicated, the control mechanism must be integrated to simplify the driver's operation and ensure driving safety.

Referring to FIG. 1, a schematic diagram of controlling a vehicle-mounted device 11 by a portable terminal 10 according to the prior art is shown. After the connection between the vehicle-mounted device and the portable terminal is confirmed, the whole device functions of the vehicle-mounted device 11 are copied to the portable terminal 10 through Bluetooth or wireless transmission, and the frame 12 is synchronically displayed on the portable terminal 10 and the vehicle-mounted device 11. The portable terminal 10 synchronically operates the frame 12 to generate an operation signal, and then transmits the operation signal to the vehicle-mounted device 11 through Bluetooth or wireless transmission to control the frame 12 of the vehicle-mounted device 11.

However, the efficiency and hardware specification of the built-in portable terminal 10 normally cannot match the vehicle-mounted device 11 and cannot receive or quickly copy the whole device functions, hence delaying or reducing the immediacy in controlling the vehicle-mounted device 11. Since the portable terminal 10 and the vehicle-mounted device 11 must have a consistent or compactible platform (such as the Android system) to synchronically display the frame 12, only limited product type of the portable terminal 10 can be integrated with the vehicle-mounted device 11.

According to another prior art, the portable terminal 10 pre-determines corresponding operation of the vehicle-mounted device 11 by using the operation button 13 or sensing the movement of the operation and transmits the operation signal to the vehicle-mounted device 11 through Bluetooth or wireless transmission to control the vehicle-mounted device 11 in a remote control manner and replace the remote controller of the vehicle-mounted device 11.

The prior art portable terminal can only perform simple AV operations of the vehicle-mounted device 11 such as volume control, forward/reverse, and cannot completely perform the complicated operations of the vehicle-mounted device 11 such as locating a destination for navigation and zooming/switching the screen etc. various operations nor generate corresponding operations in an intuitive manner for the user. Therefore, the portable terminal still has many problems to tackle with when it comes to controlling the vehicle-mounted device.

### SUMMARY OF THE INVENTION

According to an embodiment of the present invention, a method for controlling a vehicle-mounted device by a portable terminal is provided. By pre-forming corresponding operation modules for each device function of the vehicle-mounted device, the specification and capacity required for copying the device function to the portable terminal are reduced and the application of the portable terminal can thus be expanded.

According to another embodiment of the present invention, a method for controlling a vehicle-mounted device by a portable terminal is provided. By selecting a plurality of operation modules corresponding to the device functions and copying those operation modules occupying smaller memory space to the portable terminal, the control for the vehicle-mounted device can thus be speeded.

According to an alternate embodiment of the present invention, a method for controlling a vehicle-mounted device by a portable terminal is provided. By setting a password on the select operation of copying the safe operation module to the portable terminal, personal or vehicle information are protected and will not be leaked out.

To achieve the above objects, the method for controlling a vehicle-mounted device by a portable terminal of the invention comprises the following steps. The vehicle-mounted device is turned on. A synchronous mode is started. Connection to the portable terminal is confirmed. The vehicle-mounted device is switched to the synchronous mode. The operation module corresponding to the device function is dragged and selected for transmitting stored operation modes of the operation module to the portable terminal. An operation module on the portable terminal is started for enabling the vehicle-mounted device to playback the function mode corresponding to the stored pattern of the operation module and controlling the vehicle-mounted device by operating the operation module on the portable terminal.

A boot screen of the vehicle-mounted device of the invention displays a plurality of device functions and a synchronous block. The synchronous block is for starting the synchronous mode to display corresponding operation module of each device function and a device function select and drag block. The selected operation module must be dragged to the device function select and drag block to complete the operation of selection. When selecting and dragging the operation module of the safe device function, a correct input of password is required for dragging the safe operation module. The safe operation module cannot be dragged if the input password does not match.

With respect to the unique operating characteristics of each device function, the vehicle-mounted device of the invention pre-determines and pre-stores a pattern of operation mode corresponding to each operation module. Each operation mode is of an operation format which occupies a smaller memory space than that occupied by a device function mode. The portable terminal operates the operation mode to generate an operation signal, and transmits the operation signal to the vehicle-mounted device through Bluetooth or wireless transmission to control the vehicle-mounted device.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 a schematic diagram of controlling a vehicle-mounted device by a portable terminal according to the prior art;

FIG. 2 shows a boot screen of a vehicle-mounted device according to a first embodiment of the invention;

FIG. 3 shows operation modes of device functions according to a first embodiment of the invention;

FIG. 4 shows a schematic diagram of a vehicle-mounted device transmitting device functions to a portable terminal according to a first embodiment of the invention;

FIG. 5 shows a flowchart of a method for controlling a vehicle-mounted device by a portable terminal according to a first embodiment of the invention;

FIG. 6 shows a schematic diagram of a vehicle-mounted device transmitting device functions to a portable terminal according to a second embodiment of the invention;

FIG. 7 shows a flowchart of a method for controlling a vehicle-mounted device by a portable terminal according to a second embodiment of the invention.

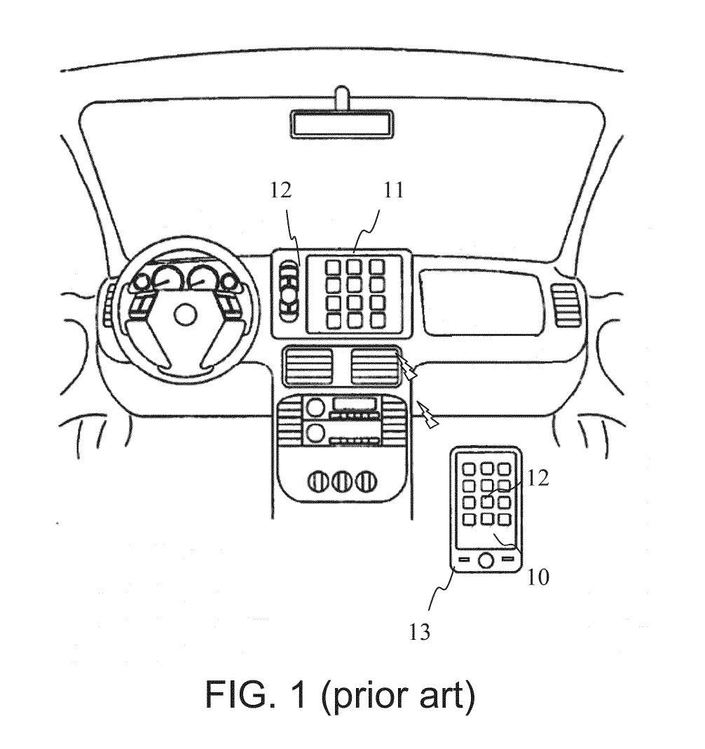

### DETAILED DESCRIPTION OF THE INVENTION

The technologies adopted to achieve the objects of the invention and the effects thereof are disclosed below in a number of exemplarily embodiments with accompanying drawings.

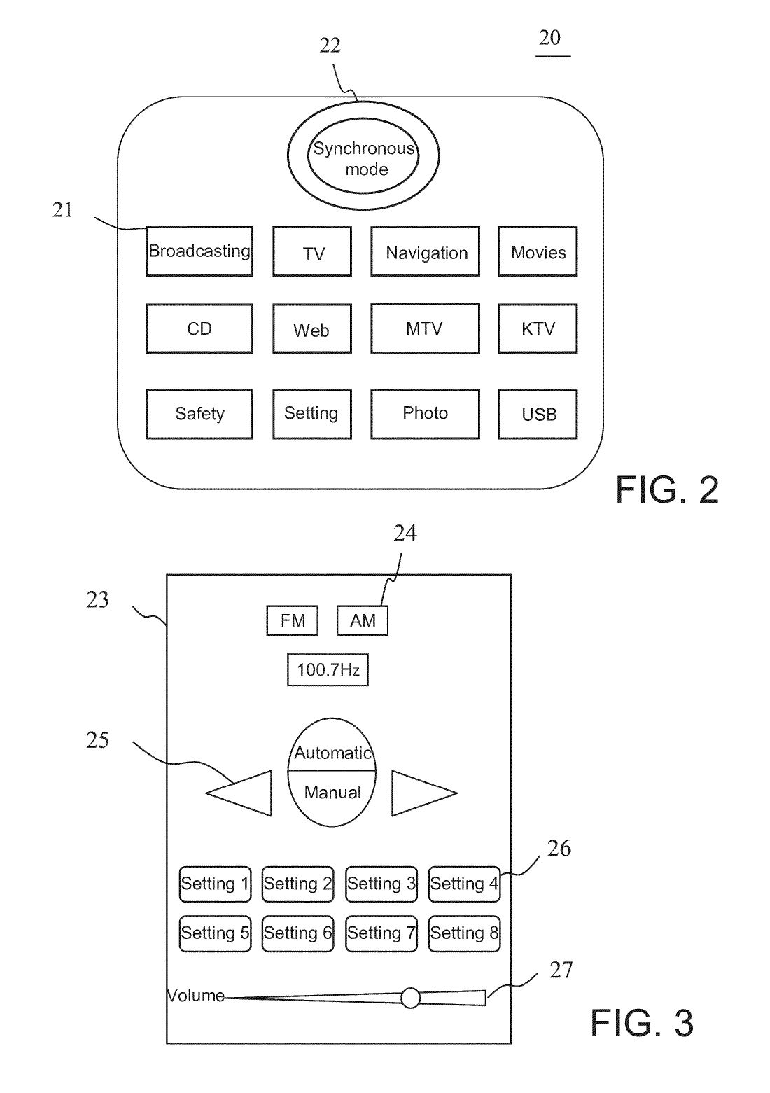

Referring to FIG. 2 and FIG. 3. FIG. 2 shows a boot screen of a vehicle-mounted device according to a first embodiment of the invention. FIG. 3 shows operation modes of device functions according to a first embodiment of the invention. The vehicle-mounted device 20 of the invention is such as a touch-screen host or an audio/video (AV) host on a vehicle. Then the vehicle-mounted device 20 is booted, the boot screen displays a plurality of operable device functions 21 and a synchronous block 22. Example of the device functions 21 are broadcasting, TV, navigation, web and CD etc.

With respect to the unique operating characteristics of each device function 21, the vehicle-mounted device 20 pre-determines and pre-stores the pattern of operation mode corresponding to each operation module. Let the broadcasting device function 21 be taken for example. As indicated in FIG. 3, the operation mode of the operation module 23 corresponding to the broadcasting device function is pre-determined. The pattern of broadcasting operation module 23 has a broadcasting frequency display region 24, an adjustment region 25, a setting region 26 and a volume adjustment region 27. The display region 24 displays the current radio frequency. The adjustment region 25 allows the user to adjust the broadcasting frequency either manually or automatically. The setting region 26 allows the user to set and store favorite or most often picked broadcasting frequencies for quick switching. The volume adjustment region 27 allows the user to adjust the volume. The above regions provide a complete set of operations for listening to the broadcasting.

When any of the device functions 21 is touched, the vehicle-mounted device 20 will be switched to a corresponding function mode. For example, when the navigation block is touched, the vehicle-mounted device 20 enters a navigation mode, and directly playback a navigation frame. When the synchronous block 22 is touched, the vehicle-mounted device 20 searches for a matched portable terminal within a pre-determined range from the vehicle-mounted device 20 through Bluetooth or wireless transmission. The portable terminal is an electronic device such as a smart phone or a tablet PC, and the pre-determined search range is within 5 or 10 meters to the vehicle. Each mode of the operation module 23 is of an operation format which occupies a smaller memory space simpler than that of the device function 21 having to display A/V frame, subtitle or playback progress.

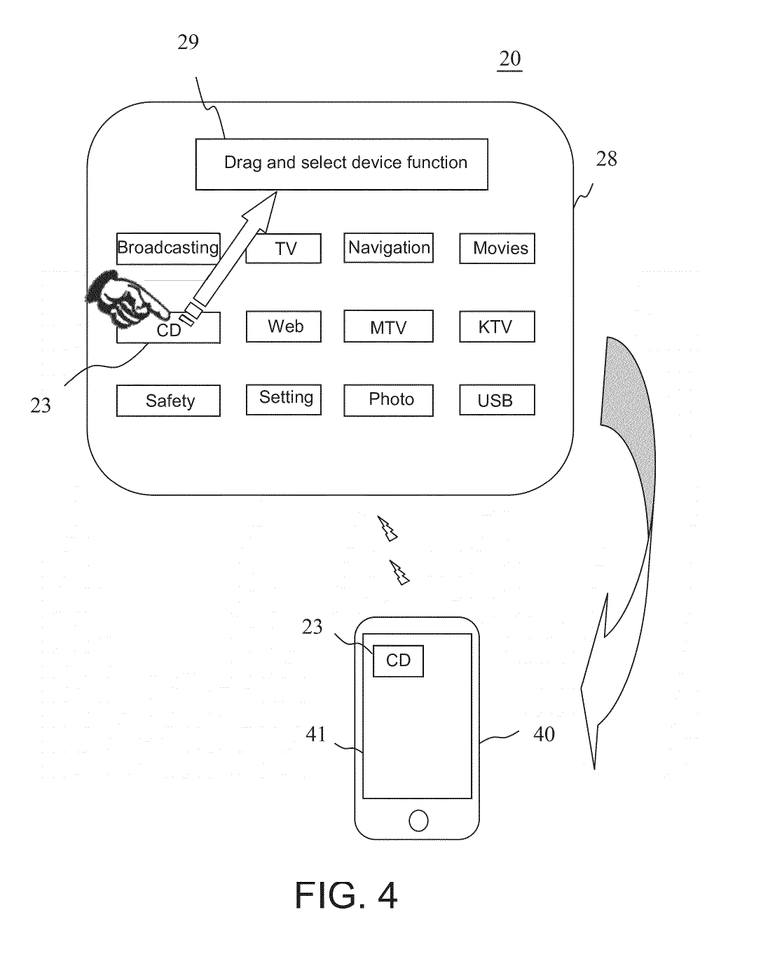

Referring to FIG. 4, a schematic diagram of a vehicle-mounted device transmitting device functions to a portable terminal according to a first embodiment of the invention is shown. When the vehicle-mounted device 20 finds a matched portable terminal 40, the vehicle-mounted device 20 requests confirmation of connection to the portable terminal 40. Once the connection is confirmed, the vehicle-mounted device 20 is switched to the synchronous mode 28. The synchronous mode 28 displays corresponding operation module 23 of each device function and a device function select and drag block 29. The driver selects a plurality of operation modules 23 corresponding to the device functions, and further drags the selected operation modules to the device function select and drag block 29 to complete the operation of selection. The vehicle-mounted device 20 immediately transmits a pre-stored pattern of operation modes for the operation module 23 to the portable terminal 40 through Bluetooth or wireless transmission. Those modes of the operation module 23 which are of simplified operation format and occupy smaller memory space are more compatible with the ordinary portable terminal 40. When the portable terminal 40 receives the operation modes, the frame 41 displays a plurality of corresponding operation modules 23. The driver may place the portable terminal 40 at a position convenient for the driver to check. Alternatively, a passenger at the back seat may hold the portable terminal 40 and start one of the operation modules 23 on the portable terminal 40. Then, the driver operates the portable terminal 40 for enabling the vehicle-mounted device 20 to playback the function mode, display the operation modes of the operation module 23 corresponding to the function mode, generate an operation signal, and further transmit the operation signal to the vehicle-mounted device 20 through Bluetooth or wireless transmission to achieve the object of controlling a corresponding device function of the vehicle-mounted device 20.

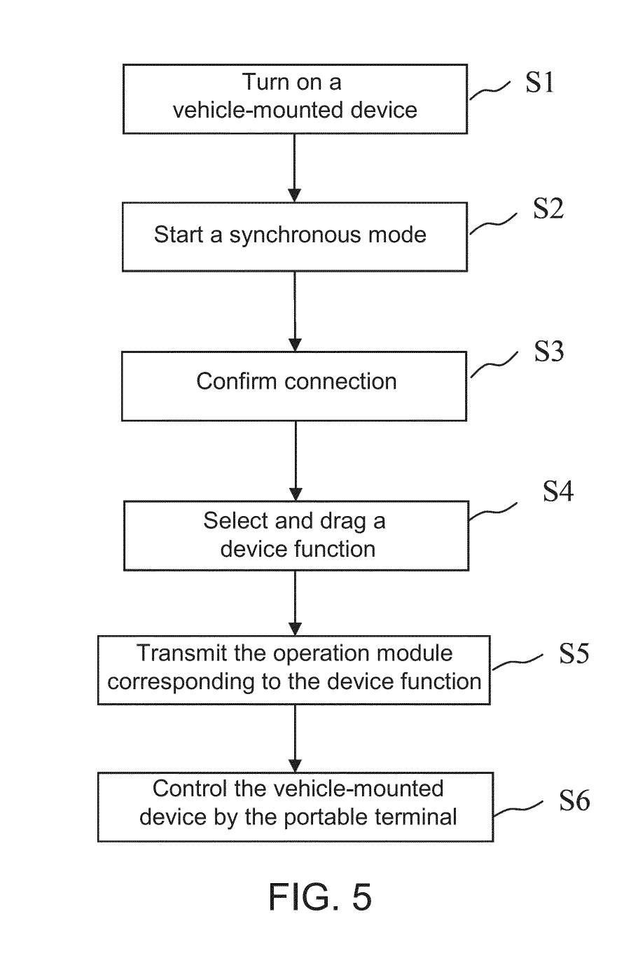

Referring to FIG. 5, a flowchart of a method for controlling a vehicle-mounted device by a portable terminal according to a first embodiment of the invention is shown. Detailed steps of controlling a vehicle-mounted device by a portable terminal are disclosed below. Firstly, at step S1, the vehicle-mounted device is booted. Next, at step S2, a synchronous mode is started. Then, at step S3, once connection to the portable terminal is confirmed, the vehicle-mounted device is switched to the synchronous mode. Then, at step S4, the operation module corresponding to the device function is selected and dragged. Then, at step S5, the stored operation modes of the operation module corresponding to the device function is transmitted to the portable terminal by the vehicle-mounted device. Then, at step S6, an operation module on the portable terminal is touched and started for enabling the vehicle-mounted device to playback corresponding function mode and control the vehicle-mounted device by operating the operation modes displayed on the portable terminal.

Through the above steps, in the method for controlling a vehicle-mounted device by a portable terminal according to the first embodiment of the invention, the portable terminal can copy operation mode occupying smaller memory space for each device function of the vehicle-mounted device, such that the specification and capacity required for copying the device function by the portable terminal are reduced, and the application of the portable terminal can be expanded. By selecting a part of operation modules without copying all of the operation modules occupying larger memory space to the portable terminal, the operation signal can be quickly transmitted to the portable terminal and the control of the vehicle-mounted device can thus be speeded.

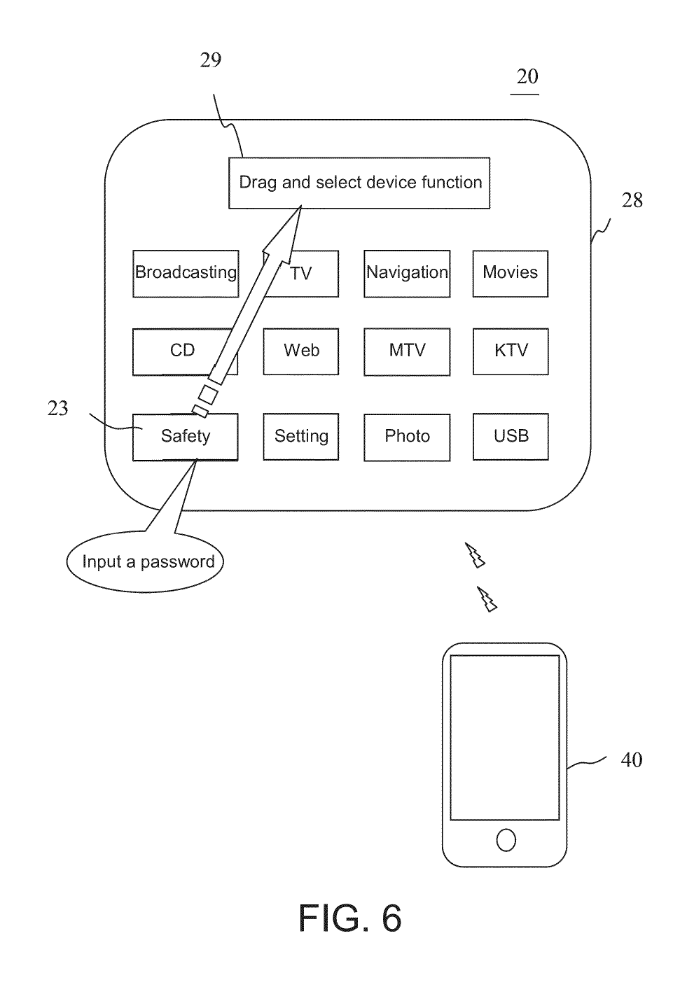

Referring to FIG. 6, a schematic diagram of a vehicle-mounted device transmitting device functions to a portable terminal according to a second embodiment of the invention is shown. The basic structure according to the second embodiment of the invention is similar to that of the first embodiment. To simplify the description, components common to the first and the second embodiments retain the numeric designation used in the first embodiment. The second embodiment is different from the first embodiment mainly in that: the driver sets a password on the safe device function of the vehicle-mounted device 20 to protect confidential personal or vehicle information stored in the safe device function files from being copied or leaked without permission. Therefore, when the synchronous mode 28 drags the selected safe operation module 23, the vehicle-mounted device 20 will request an input of password, and the safe operation module 23 can be dragged to the device function select and drag block 29 only if the input of password is correct. If the input of password does not match, the safe operation module 23 cannot be dragged to the device function select and drag block 29, such that the safe device function will not be started without permission.

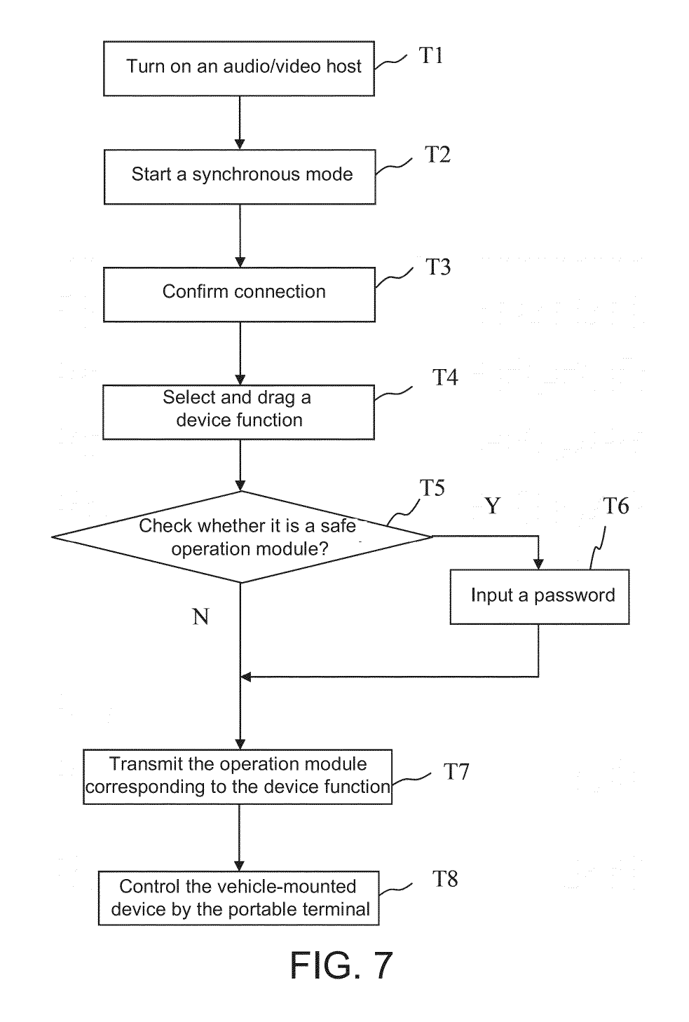

Referring to FIG. 7, a flowchart of a method for controlling a vehicle-mounted device by a portable terminal according to a second embodiment of the invention is shown. Detailed steps of controlling a vehicle-mounted device by a portable terminal are disclosed below. Firstly, at step T1, the vehicle-mounted device is booted. Next, at step T2, a synchronous mode is started. Then, at step T3, once connection to the portable terminal is confirmed, the vehicle-mounted device is switched to the synchronous mode. Then, at step T4, the operation module corresponding to the device function is selected and dragged. Then, at step T5, whether the selected and dragged operation module is a safe operation module is checked. If the selected and dragged operation module is a safe operation module, the method proceeds to step T6, an input of password is requested, and the safe operation module can be dragged only if the input of password is correct. If the input of password does not match, the safe operation module cannot be dragged to the device function select and drag block. If the safe operation module of the device function is not dragged, the method proceeds to step T7, the stored operation modes of the operation module is transmitted to the portable terminal by the vehicle-mounted device. Then, at step T8, an operation module of the portable terminal is touched and started for enabling the vehicle-mounted device to playback corresponding function mode and control the vehicle-mounted device by operating the operation modes displayed on the portable terminal.

Through the above steps, the method for controlling a vehicle-mounted device by a portable terminal according to the second embodiment of the invention can set a password on the operation module corresponding to the operation of selecting and dragging the safe device function, and the operation signal can be copied to the portable terminal only if the password is correct, such that the stored confidential personal or vehicle information are protected from being copied or leaked without permission.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for controlling a vehicle-mounted device by a portable terminal, comprising:
turning on the vehicle-mounted device;
starting a synchronous mode;
confirming connection to the portable terminal and switching the vehicle-mounted device to the synchronous mode;
selecting at least an operation module corresponding to a device function on the vehicle-mounted device;
transmitting stored operation modes of the operation module to the portable terminal by the vehicle-mounted device; and
starting the operation module of the portable terminal for enabling the vehicle-mounted device to playback a function mode corresponding to the operation module, and controlling the vehicle-mounted device by operating the operation modes on the portable terminal.

2. The method for controlling a vehicle-mounted device by a portable terminal according to claim 1, wherein a boot screen of the vehicle-mounted device displays a plurality of device functions and a synchronous block, and the synchronous block is for starting the synchronous mode.

3. The method for controlling a vehicle-mounted device by a portable terminal according to claim 2, wherein after the vehicle-mounted device is switched to the synchronous mode, the synchronous mode displays corresponding operation module for each device function and a device function select and drag block.

4. The method for controlling a vehicle-mounted device by a portable terminal according to claim 3, wherein the selected operation module must be dragged to the device function select and drag block to complete the operation of selection.

5. The method for controlling a vehicle-mounted device by a portable terminal according to claim 1, wherein, with respect to the unique operating characteristics of each device function, the vehicle-mounted device pre-determines and pre-stores a pattern of operation modes corresponding to each operation module.

6. The method for controlling a vehicle-mounted device by a portable terminal according to claim 5, wherein the operation mode is of an operation format which occupies a memory space smaller than that occupied by the device function mode.

7. The method for controlling a vehicle-mounted device by a portable terminal according to claim 1, wherein the vehicle-mounted device searches for the portable terminal within a pre-determined range from the vehicle to establish connection.

8. The method for controlling a vehicle-mounted device by a portable terminal according to claim 1, wherein the portable terminal operates the operation modes to generate an operation signal, and further transmits the operation signal to the vehicle-mounted device through Bluetooth or wireless transmission to control the vehicle-mounted device.

9. The method for controlling a vehicle-mounted device by a portable terminal according to claim 1, wherein the selected operation module request an input of password when the selected operation module is checked and determined as a safe operation module of the device function.

10. The method for controlling a vehicle-mounted device by a portable terminal according to claim 9, wherein the safe operation module is dragged only if the input of password is correct.

11. The method for controlling a vehicle-mounted device by a portable terminal according to claim 9, wherein the safe operation module cannot be dragged if the input of password does not match.
